(19) United States
(12) Patent Application Publication
(10) Pub. No.: US 2026/0349290 A1
(43) Pub. Date: Nov. 5, 2026

(54) ELECTRO-OPTIC DEVICE WITH PASSIVATED BTO AND METHOD OF FABRICATION THEREFOR

(71) Applicant: Lumiphase AG, Stäfa (CH)

(72) Inventors: Stefan Abel, Zürich (CH); Felix Eltes, Zürich (CH); Timo Schumann, Eschenbach (CH); Lukas Czornomaz, Kilchberg (CH)

(21) Appl. No.: 19/483,753

(22) PCT Filed: Apr. 19, 2024
(86) PCT No.: PCT/IB2024/053856

§ 371 Date: Nov. 12, 2025

Related U.S. Application Data
(60) Provisional application No. 63/502,425, filed on May 16, 2023.

(51) Int. Cl. G02F 1/035

(52) U.S. Cl. CPC G02F 1/035

(57) ABSTRACT

An electro-optic method and device including a passivation or protection structure for Pockels materials. This can be a single layer of or possibly a stack of several layers of different materials. Typically, this structure is located between a waveguide, such as one containing silicon nitride and the Pockels material, such as a BTO (BaTiO3) layer. It has been discovered that a reduction reaction of BTO severely alters the layer properties (primarily increasing conductivity and optical absorption).

### RELATED APPLICATIONS

This application claims the benefit under 35 U.S.C. § 119(e) of U.S. Provisional Application No. 63/502,425, filed on May 16, 2023, which is incorporated herein by reference in its entirety.

### BACKGROUND OF THE INVENTION

Silicon photonics have become a platform for dense and low-cost photonic integrated circuits (PIC) for a wide range of applications that, in many cases, require fast and energy-efficient electro-optical (EO) switches.

Silicon modulators have major constraints, however. Fast modulation of only the optical phase is not possible, as changes in real and imaginary parts of the refractive index are linked. In addition, their operating speed is limited by charge-carrier lifetimes in forward-biased or reverse-biased devices. The silicon based state-of-the-art modulators often employ differently doped regions in the waveguides. Higher doping is required for higher speed operation, but higher doping increases absorption. Another option is heater-based devices. Here, a heater (often metal wire) changes the temperature via Joule heating (an electrical current), and consequently changes the temperature in a waveguide in close proximity but far enough that the optical mode does not see the strongly optically absorbing heater conductor. Such heater-based devices tend to be slow, have high power consumption, and can suffer from crosstalk.

Pockels materials avoid these problems. In such materials, a change of the refractive index is induced by an electric field. But no Pockels effect exists in a centrosymmetric crystal such as silicon. Thus, materials with sizeable Pockels coefficients must be integrated onto silicon photonic structures to combine the benefits of bulk Pockels modulators with the low fabrication costs of integrated silicon photonics.

Several approaches exist for integrating a material with a large effective Pockels effect in silicon based modulators. For example, the Pockels effect is present in lithium niobate (LiNbO₃, LN) single crystals. And, lithium niobate has been integrated with silicon waveguides, e.g. via wafer bonding techniques. However, the size mismatch between LN wafers and silicon wafers renders the integration process difficult to scale to large substrate sizes, which results in rather high chip costs.

Barium titanate (BaTiO₃, BTO), for several reasons, has emerged to enable Pockels-effect-based devices on silicon. First, BTO has one of the largest Pockels coefficients. Second, it has previously been used in thin-film EO modulators on small-size oxide substrates. Third, BTO may be grown on silicon substrates with large wafer sizes, and with excellent crystal quality, and so forth. BTO-based photonic electro-optic components on silicon wafers have been demonstrated.

### SUMMARY OF THE INVENTION

Integrating Pockels materials such as BTO into wafer-scale processes necessitates that the material be protected from the necessary processes. For example, BTO's electro-optical properties (primarily optical losses and leakage current) may be altered when exposed to certain chemical species in the form of gases, plasmas, ambient humidity.

Currently, BTO layer can often be exposed to numerous complex processing steps during the fabrication of products. Each of these process steps, and more in particular those where BTO is directly exposed, may deteriorate the electro-optical properties and largely degrade yield or make it impossible to produce devices with suitable performance.

In particular, it has been discovered that a reduction reaction of BTO severely alters the layer properties (primarily increasing conductivity and optical absorption). That is, exposing BTO layer to hydrogen radicals during manufacturing or operation of BTO-based photonic devices is detrimental to the device's performance. Such exposure can arise from hydrogen radicals during e.g. plasma-based deposition of dielectrics (such as silicon nitride (SiN) or silicon dioxide (SiO2)), plasma-based etching of dielectrics or metals, or through ambient humidity.

At the same time, it is also often necessary to allow oxygen into a BTO layer such as during annealing.

The present invention involves the introduction of a passivation or protection structure for Pockels materials. This can be a single layer of or possibly a stack of several layers of different materials. Typically, this structure is located between a waveguide, such as one containing silicon nitride and the Pockels material, such as a BTO (BaTiO3) layer. In one current design, BTO-based ridge waveguides employ a planar layer of BTO for the vertical confinement of light and a structured layer of silicon nitride on top of the BTO. The silicon nitride layer provides lateral and directional confinement of light.

In other examples, other variants of the Pockels material are used such as different possible compositions of (B,S)TO ((Ba,Sr)TiO3) including possible doping elements.

In this configuration, the passivation structure can block access of hydrogen radicals to the Pockels material layer during fabrication and/or later at ambient, storage or operating conditions.

In addition, the passivation structure can largely mitigate access of hydrogen radicals to the Pockels material layer during manufacturing, when exposed to plasmas or gases containing hydrogen radicals for temperatures ranging from ambient to few hundreds of degrees Celsius (typical CMOS BEOL processing temperatures) (0-400 C). The passivation structure also can help with outgassing of hydrogen radicals from and oxidation (ingress of oxygen into) of Pockels material at more elevated annealing temperatures such as 300 C-800 C.

In many ways, the inclusion of such a passivation structure is counter intuitive. On first impressions, it would appear to degrade the electro-optical properties of the SiN/BTO ridge waveguide, for example. When positioned between the SiN and BTO layers, at the core of the waveguide where the highest optical power is present, the protective layer decreases the modal overlap of the light with the BTO layer, and therefore lowers the effective electro-optical response of the waveguide (which in principle should be maximized).

However, with a proper passivation structure (materials, layering, and thicknesses), one can simultaneously adjust diffusion properties of hydrogen radicals and largely mitigate the detrimental impact on mode overlap with BTO (electro-optical efficiency).

The passivation structure should be thin enough and, preferably, have a lower effective refractive index than the SiN and BTO. “Effective index” corresponds to the index of a homogenous material, that could replace the layer stack and result in the (almost) identical properties of the optical mode. Also, the passivation structure should contain materials with low hydrogen permeation rates.

The small resulting degradation of electro-optical efficiency due to the presence of the passivation structure is largely compensated by the associated mitigation of subsequent optical loss and leakage degradation during manufacturing.

In many examples, the passivation structure comprises a thin layer of silicon dioxide (SiO2), or possibly, a stack containing alternating SiO2/SiN/SiO2 layers. It currently further includes the STO layer, specifically a several nanometer thick, e.g., 4 nanometers (nm), STO between BTO and SiO2 cap. In other examples, the BTO is in direct contact with the passivation stack, however.

In addition, the passivation structure provides a few additional benefits. It can protect BTO surface from etch defects during plasma etching of SiN waveguide, wet chemistries (etchants, solvents). In addition, the passivation structure can function as an etch stop to prevent the BTO layer from being over-etched at the location of highest optical power when patterning SiN waveguide (which would deteriorate the optical overlap).

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIGS. 1A, 1B, 1C, 1D, 1E, 1F, and 1G are cross-sectional views showing the fabrication of an electro-optic device according to the invention;

FIGS. 2A, 2B, 2C, and 2D are cross-sectional views showing alternative fabrication steps of an electro-optic device according to the invention; and

FIG. 3 is a cross-sectional view showing another example of an electro-optic device according to the invention.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Also, all conjunctions used are to be understood in the most inclusive sense possible. Thus, the word “or” should be understood as having the definition of a logical “or” rather than that of a logical “exclusive or” unless the context clearly necessitates otherwise. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

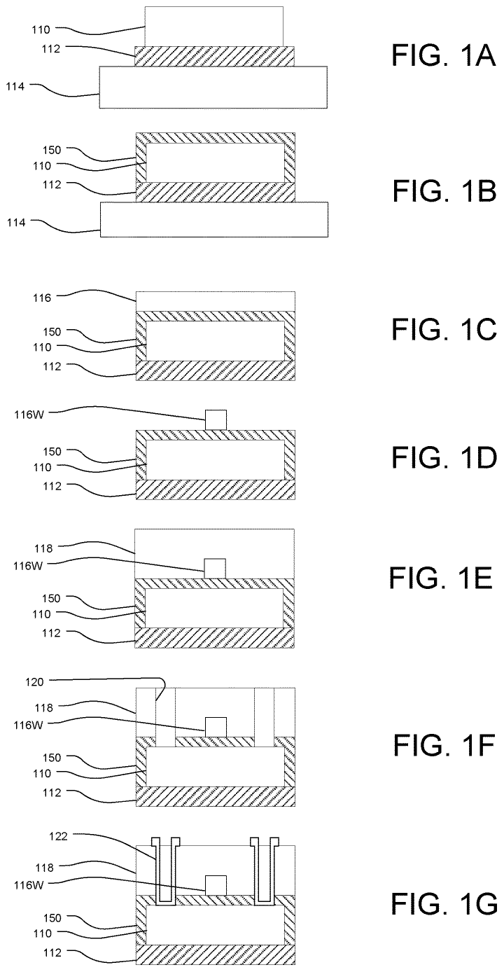

FIGS. 1A, 1B, 1C, 1D, 1F, and 1G are cross-sectional views showing the fabrication of an electro-optic device such as an active phase shifter.

In more detail, FIG. 1A shows an early stage in the production of the device. The Pockels material 110 has been patterned on a lower cladding layer 112. Both of these layers are supported on a wafer 114 such as a silicon wafer.

Typically, the Pockels material 110 is first introduced as a blanket film, then patterned in a wet or dry etch. Generally, the Pockels material is a material that exhibits a change of refractive index under an applied electric field (Pockels effect). Currently the Pockels material is BTO or BSTO (barium-strontium titanate ((Ba,Sr)TiO₃)). Currently, the refractive index is about 2.3 and the thickness is between 200-250 nm for the Pockels material layer 110.

FIG. 1B shows the next step in the fabrication process. A passivation structure 150 is deposited to encapsulate the Pockels layer 110. Its thickness could range from a few, such as 2) nanometers to 100 nanometers (nm). Currently the structure is 25 nm thick, but is typically in the range is 5-50 nm. In any event, it is typically less than 50% of the thickness of the subsequent waveguide 116W. Its effective refractive index in the range 1.44-2.1

In general, the passivation structure 150 comprises one or more layers and should satisfy the following properties: Low optical absorption in wavelength range of operation of the electro-optic device, low permeation rate of hydrogen radicals, and preferably, an effective refractive index lower than waveguide layer (SiN) and Pockels material 110.

The passivation structure 150 often comprises one or more of the following materials: SiO2, SiN, Si, Al2O3, STO, CaTiO3, SrO, superlattices of BTO/STO, and/or epitaxial oxides (SrHfO3, BaHfO3, SrZrO3, BaZrO3). In addition, the passivation structure can include other layers that can trap hydrogen and be low optical loss and low optical index such as Tungsten oxide, Chromium oxide, Boron nitride, Aluminum nitride, Zirconium nitride. See Hydrogen permeation barriers: Basic requirements, materials selection, deposition methods, and quality evaluation, by Vincenc Nemanic̆, Nuclear Materials and Energy, Volume 19, May 2019, Pages 451-457.

There are several practical examples of the passivation structure 150. SiO2 can be deposited or grown (e.g., thermal oxidation) before bonding. SiO2/SiN/SiO2 tri-layer that functions like a “mini” humidity cap can be used. SiO2/Al2O3/SiO2 tri-layer is expected to be very good at blocking hydrogen. Si(amorphous)+SiO2 is another option. Still another option is an additional SrTiO3 (STO) layer on top of BTO. Currently, BTO is grown on Si, in which a 4 nm layer of STO is first grown on Si and then the thick BTO layer on top. As a result, after wafer bonding, that 4 nm layer of STO ends-up being located at the top of the BTO layer. Therefore, in the passivation layer or stack and the waveguide material, the resulting stack is: lower cladding, BTO, 4 nm STO, passivation stack, SiN waveguide. The role of STO itself in hydrogen blocking is not clear, however.

FIG. 1C shows the deposition of the waveguide layer 116. In the illustrated next step, the waveguide layer 116 is patterned into the waveguide 116W as shown in FIG. 1D. The passivation structure is used, for example, to protect the Pockels material during the fabrication of this waveguide 116W, and particularly during the etch process to pattern the waveguide layer 116 into the waveguide 116W. Generally, the waveguide 116W is an amorphous dielectric material, with a refractive index higher, lower or equal to Pockels material 110. It currently has a width of about 1 micrometer to support the optical mode (single mode for C and O bands).

FIG. 1E shows the deposition of the upper cladding layer 118. This layer has a refractive index of around 1.45 and thickness in the range of 50 nm to 3000 nm.

FIG. 1F shows the opening of contact vias 120. In the current embodiment, these contact openings extend downward through the upper cladding layer 118, and through the passivation layer 150.

In FIG. 1G, the metal contacts 122 are fabricated in the contact openings 120. The metal extends to or near the Pockels layer 110. In some cases, the passivation is left below the contact, such as a tunnel contact. This can help mitigate the reaction between the metal and the BTO.

Because the passivation structure 150 occupies the center of the optical mode that extends between the waveguide 116W and the Pockels layer, its refractive index is important. The passivation structure 150 has a lower detrimental impact if its effective index is lower than the refractive index of Pockels material 110 and the waveguide 116W.

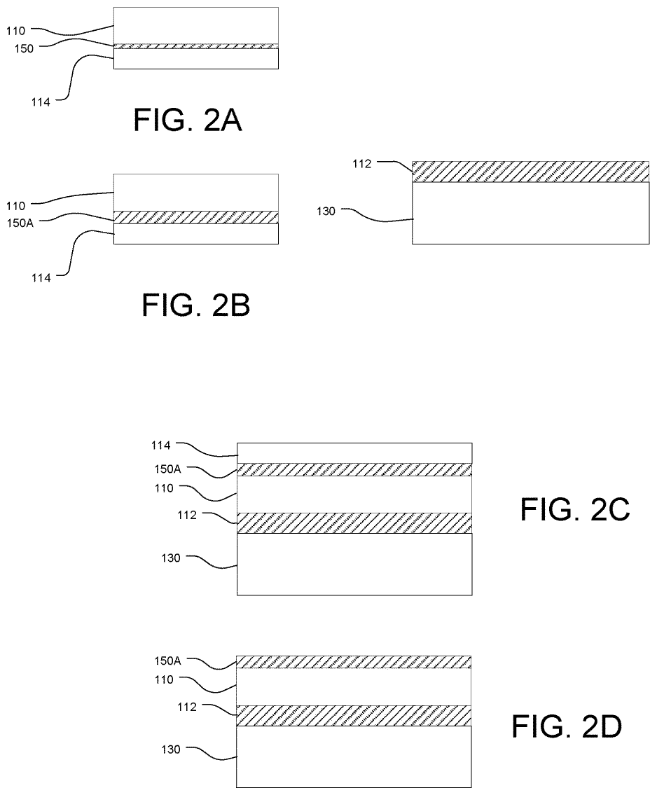

FIGS. 2A, 2B, 2C, and 2D are cross-sectional views showing the fabrication of an electro-optic BTO device such as an active phase shifter according to another embodiment, by employing a transfer process.

FIG. 2A shows the results of the initial steps. A seed passivation structure 150 is deposited or grown on a wafer 114. The Pockels material 110 is then deposited or otherwise transferred onto the passivation structure 150.

In the specific current example, after epitaxy, a thin (about 2-4 nm) seed SiOx interface exists between the wafer substrate and the Pockels material 110.

While not shown, STO can be used with any additional interface layer underneath the BTO. In more detail, currently, a thin layer of STO is first grown on Si, followed by the deposited BTO. With the deposition of the BTO film, the interface between Si and STO starts to oxidize, which results in the formation of 2-4 nm of SiO2 between the Si substrate and the STO layer. And, this SiO2 layer can be made thicker by annealing the Si/STO/BTO stack in oxygen at high temperature just after the BTO epi process. That can result in the 2-4 nm SiO2 interfacial layer growing up to 25-30 nm or more.

FIG. 2B shows the annealing of the seed passivation structure to create a new layer 150A. Specifically, the as-grown wafer is annealed in an oxidizing atmosphere (air/oxygen/Ar+water vapor . . . ) the silicon near the interface oxidizes, forming a high-quality thermal silicon oxide. The thickness can be controlled by temperature/time/atmosphere and is generally annealed to a thickness of between 5 and 20 nm, but can have a thickness up to 100 nm or more.

In parallel, the lower cladding layer 112 is deposited on a handle or transfer wafer 130.

FIG. 2C shows the transfer of the lower cladding layer 112 on to the Pockels material 110. Specifically, the donor wafer 114 with the Pockels layer 110 is flipped and placed on and wafer bonded to the lower cladding material 112. Then in a separate processing step the donor wafer 114 is removed such as with one of, or a combination of, lapping, grinding, chemical mechanical polishing (CMP), and wet etching. The etchant is chosen to be selective to the wafer, with the thermal SiOx passivation structure serving as an etch-stop.

FIG. 2D shows the removal of the donor wafer 114. This leaves the Pockels layer 110 protected by the passivation layer 150A. However, in this example, the Pockels material is not encapsulated as in FIG. 1B.

Thereafter, further processing can be performed as described in FIGS. 1C through 1G, where the waveguide 116W and the further cladding layers are deposited along with the formation of the metal contacts.

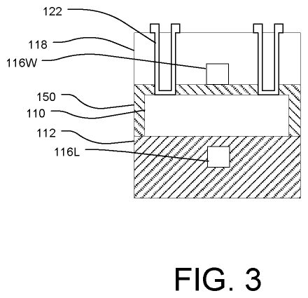

FIG. 3 shows another embodiment. Here, the phase shifter further includes a second, lower waveguide 116L below or in the BTO layer and running parallel to the upper waveguide 116W. Its addition improves the optical overlap by “pulling down” the optical mode towards the lower waveguide 116L.

While this invention has been particularly shown and described with references to preferred embodiments thereof, it will be understood by those skilled in the art that various changes in form and details may be made therein without departing from the scope of the invention encompassed by the appended claims.

1. An electro-optic device comprising:
a waveguide;
Pockels material adjacent to and/or including the waveguide;
an upper cladding layer over the waveguide; and
a passivation structure between the waveguide and the Pockels material.

2. The electro-optic device of claim 1, wherein the waveguide is silicon nitride.

3. The electro-optic device of claim 1, wherein the passivation structure has a lower refractive index than the waveguide and/or the Pockels material.

4. The electro-optic device of claim 1, wherein the passivation structure includes silicon dioxide.

5. The electro-optic device of claim 1, wherein the passivation structure includes silicon dioxide and silicon nitride.

6. The electro-optic device of any of claim 1, wherein the passivation structure is between 2 and 100 nm thick.

7. The electro-optic device of any of claim 1, wherein materials of the Pockels material include Barium Titanate (BaTiO₃).

8. The electro-optic device of any of claim 1, wherein materials of the Pockels material include barium-strontium titanate ((Ba,Sr)TiO₃).

9. The electro-optic device of any of claim 1, wherein the Pockels material can be one or more layers.

10. The electro-optic device of any of claim 1, further comprising a lower cladding layer under the Pockels material and/or upper cladding layer over the Pockels material.

11. The electro-optic device of any of claim 1, further comprising a second waveguide lower cladding layer under the Pockels material.

12. A method for fabricating an electro-optic device, the method comprising:
forming a waveguide;
locating Pockels material adjacent to and/or including the waveguide;
providing an upper cladding layer over the waveguide; and
locating a passivation structure between the waveguide and the Pockels material to protect the Pockels material from reduction reactions during fabrication.

13. The method of claim 12, further comprising protecting the Pockels material during an etching process to form the waveguide.

14. The method of claim 12, wherein the passivation structure has a lower refractive index than the waveguide and/or the Pockels material.

15. The method of claim 12, wherein the passivation structure includes silicon dioxide.

16. The method of claim 12, wherein the passivation structure includes silicon dioxide and silicon nitride.

17. The method of any of claim 12, wherein the passivation structure is between 2 and 100 nm thick.

18. The method of any of claim 12, wherein materials of the Pockels material include Barium Titanate (BaTiO₃).

19. The method of any of claim 12, wherein materials of the Pockels material include barium-strontium titanate ((Ba,Sr)TiO₃).

20. The method of any of claim 12, further comprising forming a second waveguide in lower cladding layer under the Pockels material.
